(19) United States
(12) Patent Application Publication
(10) Pub. No.: US 2025/0031245 A1
(43) Pub. Date: Jan. 23, 2025

(54) HANDLING LBT FAILURE IN SIDELINK COMMUNICATION

(71) Applicant: Lenovo (Singapore) Pte. Ltd., New Tech Park (SG)

(72) Inventors: Prateek Basu Mallick, Dreieich (DE); Alexander Golitschek Edler von Elbwart, Darmstadt (DE); Joachim Löhr, Wiesbaden (DE); Karthikeyan Ganesan, Kronberg im Taunus (DE); Jing Han, Beijing (CN)

(21) Appl. No.: 18/771,522

(22) Filed: Jul. 12, 2024

Related U.S. Application Data
(60) Provisional application No. 63/526,585, filed on Jul. 13, 2023.

(51) Int. Cl. H04W 74/0808; H04L 1/1867; H04W 92/18

(52) U.S. Cl. CPC H04W 74/0808; H04L 1/1893; H04L 1/1896; H04W 92/18

(57) ABSTRACT

Various aspects of the present disclosure relate to generating a hybrid automatic repeat request (HARQ) feedback based on a data transmission received from a sidelink (SL) transmitter UE (UE-t) and performing a Clear Channel Assessment (CCA). Aspects of the present disclosure may further relate to incrementing a counter based on a negative CCA result and transmitting a message to the SL UE-t based at least in part on the counter reaching a predefined value, the message comprising CCA failure information for a Resource Block (RB) set.

### TECHNICAL FIELD

The present disclosure relates to wireless communications, and more specifically to techniques for overcoming Continuous Listen-Before-Talk (C-LBT) failures in sidelink (SL) communication, such as unicast Sidelink Unlicensed (SL-U) communication.

### BACKGROUND

A wireless communications system may include one or multiple network communication devices, such as base stations, which may be otherwise known as an evolved NodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology (RAT), fourth generation (4G) RAT, fifth generation (5G) RAT, among other suitable RATs beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may further include means for generating a hybrid automatic repeat request (HARQ) feedback based on a data transmission received from a SL transmitter UE (UE-t). The method and apparatuses described herein may include means for performing a Clear Channel Assessment (CCA). The method and apparatuses described herein may include means for incrementing a counter based on a negative CCA result. The method and apparatuses described herein may include means for transmitting a message to the SL UE-t based at least in part on the counter reaching a predefined value, the message comprising CCA failure information for a Resource Block (RB) set.

In some implementations, the method and apparatuses described herein may further include means for transmitting, to a SL receiver UE (UE-r), a SL data transmission on a first RB set. The method and apparatuses described herein may include means for receiving, from the SL UE-r, a message on a second RB set, the message comprising CCA failure information for the first RB set. The method and apparatuses described herein may include means for performing a retransmission of the SL data transmission based on the CCA failure information.

### BRIEF DESCRIPTION OF THE DRAWINGS

FIG. 1 illustrates an example of a wireless communications system in accordance with aspects of the present disclosure.

FIG. 2 illustrates an example of a protocol stack that supports different protocol layers in the UE and the network, in accordance with aspects of the present disclosure.

FIG. 3 illustrates an example of a SL protocol stack that supports different protocol layers in the UE-t and the UE-r, in accordance with aspects of the present disclosure.

FIG. 4 illustrates an example of a radio frame and an LBT procedure for unlicensed communication in accordance with aspects of the present disclosure.

FIG. 5A illustrates an example of unicast SL communication procedure in accordance with aspects of the present disclosure.

FIG. 5B illustrates an example of a unicast SL communication procedure performed on unlicensed spectrum in accordance with aspects of the present disclosure.

FIG. 6 illustrates an example of an improved unicast SL communication procedure performed on unlicensed spectrum in accordance with aspects of the present disclosure.

FIG. 7 illustrates an example of a procedure for performing a new transmission in response to consistent listen-before-talk (LBT) failure of the physical sidelink feedback channel (PSFCH) in accordance with aspects of the present disclosure.

FIG. 8 illustrates an example of a procedure for consistent LBT failure mitigation in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of a network equipment (NE) in accordance with aspects of the present disclosure.

FIG. 12 illustrates a flowchart of a method performed by a UE-r in accordance with aspects of the present disclosure.

FIG. 13 illustrates a flowchart of a method performed by a UE-t in accordance with aspects of the present disclosure.

### DETAILED DESCRIPTION

The present disclosure describes systems, methods, and apparatuses for handling consistent LBT failures in unicast SL-U communication. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

For SL-U communication, transmitters are expected to “sense” the medium, e.g., based on a CCA protocol, and detect transmissions from other nodes prior to transmitting. The simplest CCA method is energy detection, i.e., to measure the received energy level of signals transmitted from other devices and determine whether a channel is idle or busy.

Once a consistent Listen-Before-Talk (LBT) failure has been declared, among others it results into a situation where a SL receiver device (e.g., the UE-r) may not be able to transmit HARQ feedback about a successful or failed reception to a corresponding SL transmitter device (e.g., the UE-t). The LBT failure at the UE-r leads to a discontinuous transmission (DTX) scenario at the UE-t, where the UE-t fails to receive an expected transmission (i.e., HARQ feedback) from the UE-r. After the absence of multiple of such HARQ feedback(s), indeed a configurable value called sidelink Max Num Consecutive DTX (defined as sl-MaxNumConsecutiveDTX in Third Generation Partnership Project (3GPP) Technical Specification (TS) 38.331), the UE-t may declare that the link between it and the UE-r has met radio link failure (RLF) and the corresponding PC5-RRC connection is released. However, the RLF may be erroneously declared when the consecutive DTX is due to a busy channel, rather than a failed radio link.

While one solution would be to depend on the existing mechanism of declaring SL RLF when a UE-t does not receive sidelink Max Num Consecutive DTX HARQ feedbacks from the UE-r for its transmissions. Following this, the UEs should initiate establishment of PC5-RRC Connection afresh. However, this solution will lead to data loss due to Layer-2 (L2) release (i.e., resulting in flushing the data buffer at Packet Data Convergence Protocol (PDCP), Radio Link Control (RLC), and Medium Access Control (MAC) entities). This will affect User experience and may even lead to loss of critical data related to (public) safety.

To solve the problems with consistent LBT failure discussed herein, after attempting HARQ feedback transmission and receiving an LBT failure from lower layer, the UE-r increments a counter. When the counter reaches a predefined value (i.e., a threshold amount), the UE-r initiates a new transmission to the UE-t using different resources than those experiencing LBT failure.

By using different resources, the UE-r improves the likelihood of overcoming the channel busy condition and having a positive CCA result. By making the new transmission (i.e., on different resources), the UE-r is able to provide the HARQ feedback to the UE-t, thereby avoiding extra transmission of data the UE-r has already successfully received.

Aspects of the present disclosure are described in the context of a wireless communications system.

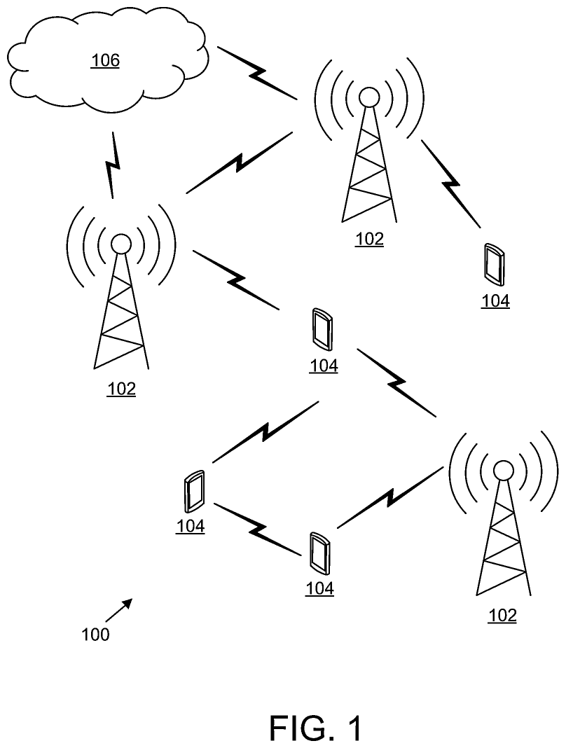

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHZ-24.25 GHZ), FR4 (52.6 GHZ-114.25 GHZ), FR4a or FR4-1 (52.6 GHz-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 KHz subcarrier spacing; and a fourth numerology (e.g., μ=3), which includes 120 kHz subcarrier spacing.

Wireless communication in unlicensed spectrum (also referred to as “shared spectrum”) in contrast to licensed spectrum offer some obvious cost advantages allowing communication to obviate overlaying operator's licensed spectrum and rather use license free spectrum according to local regulation in specific geographies. From 3GPP technology perspective, the unlicensed operation can be on the Uu interface (referred to as NR-U) or also on sidelink interface (e.g., SL-U).

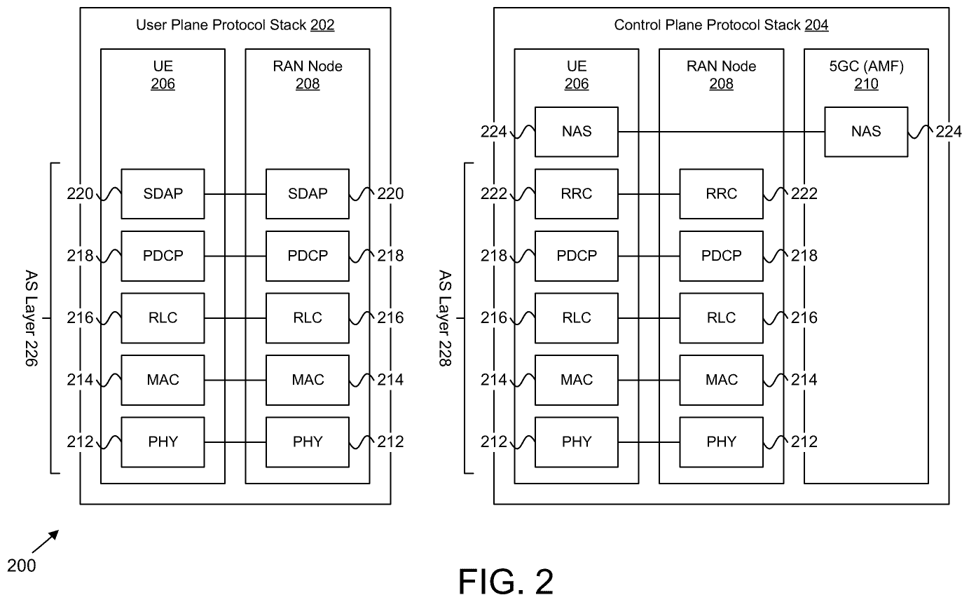

FIG. 2 illustrates an example of a NR protocol stack 200, in accordance with aspects of the present disclosure. While FIG. 2 shows the UE 206, the RAN node 208 and a 5G core network (5GC) 210 (comprising at least an AMF), these are representative of a set of UEs 104 interacting with an NE 102 (e.g., base station) and a CN 106. As depicted, the NR protocol stack 200 comprises a User Plane protocol stack 202 and a Control Plane protocol stack 204. The User Plane protocol stack 202 includes a physical (PHY) layer 212, a MAC sublayer 214, the RLC sublayer 216, a PDCP sublayer 218, and Service Data Adaptation Protocol (SDAP) sublayer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-2 (L2) is split into the SDAP, PDCP, RLC and MAC sublayers. The Layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of Signaling Radio Bearers (SRBs) and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as Transport Blocks (TBs)) from MAC Service Data Units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as uplink (UL) or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

Note that an LTE protocol stack comprises similar structure to the NR protocol stack 200, with the differences that the LTE protocol stack lacks the SDAP sublayer 220 in the AS layer 226 and that the NAS layer 224 is between the UE 206 and an MME in the EPC.

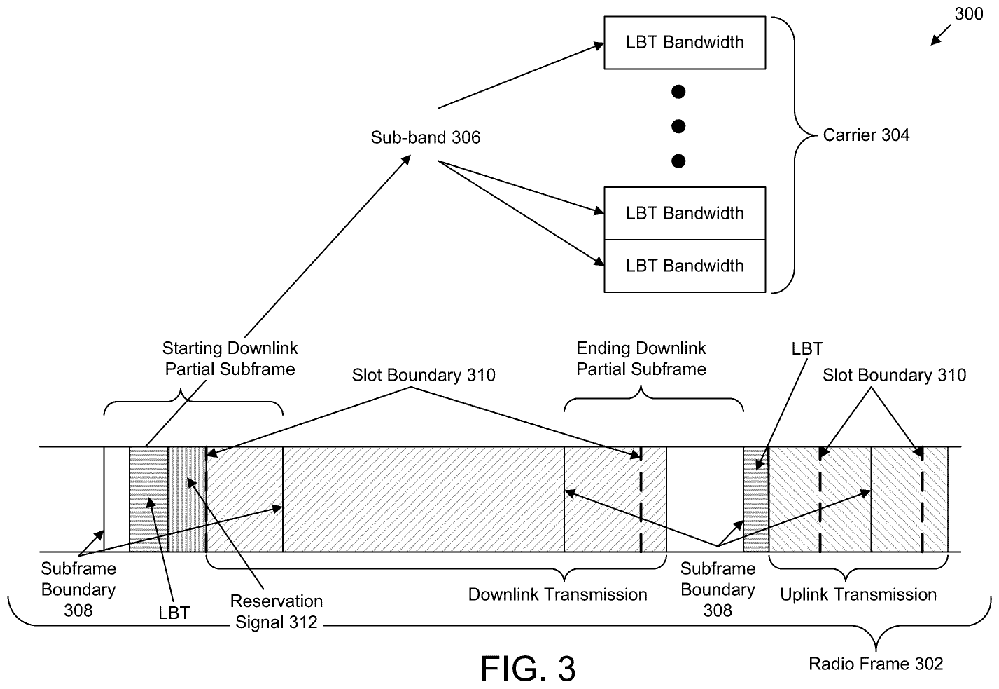

FIG. 3 depicts an LBT procedure 300 for a radio frame 302 for communication on unlicensed spectrum, according to embodiments of the disclosure. When a communication channel is a wide bandwidth unlicensed carrier 304 (e.g., several hundred MHz), the CCA/LBT procedure relies on detecting the energy level on multiple sub-bands 306 of the communications channel as shown in FIG. 3. The LBT parameters (such as type/duration, clear channel assessment parameters, etc.) may be configured in the UE 206 by the RAN node 208. In one embodiment, the LBT procedure is performed at the PHY layer 212.

FIG. 3 also depicts frame structure of the radio frame 302 for communication between the UE 206 and RAN node 208 on unlicensed spectrum. The radio frame 302 may be divided into subframes (indicated by subframe boundaries 308) and may be further divided into slots (indicated by slot boundaries 310). The radio frame 302 uses a flexible arrangements where UL and DL operations are on the same frequency channel but are separated in time. However, the subframes are not configured as a DL subframe or an UL subframe and a particular subframe may be used by either the UE 206 or RAN node 208. As discussed previously, LBT is performed prior to a transmission. Where LBT does not coincide with a slot boundary 310, a reservation signal 312 may be transmitted to reserve (i.e., occupy) the channel until the slot boundary is reached and data transmission begins.

With respect to LBT failure handling, the MAC sublayer 214 relies on reception of a notification of LBT failure from the PHY layer 212 to detect/declare consistent UL LBT failure. The UE 206 switches to another bandwidth part (BWP) and initiates a random-access procedure (i.e., RACH procedure) upon declaration of consistent UL LBT failure on a Primary Cell (PCell) or a Primary Secondary Cell (PSCell), if there is another BWP with configured Random Access Channel (RACH) resources.

The UE 206 performs RLF recovery if the consistent UL LBT failure was detected on the PCell and UL LBT failure was detected on ‘N’ possible BWP. When consistent UL LBT failures are detected on the PSCell, the UE 206 informs the RAN, via the Secondary Cell Group (SCG) failure information procedure, after detecting a consistent UL LBT failure on ‘N’ BWPs, where ‘N’ is the number of configured BWPs with configured Physical Random Access Channel (PRACH) resources. If ‘N’ is larger than one, it is up to the UE implementation which BWP the UE selects.

When consistent UL LBT failures are detected on a Secondary Cell (SCell), the UE 206 transmits a new Medium Access Control (MAC) Control Element (CE) to report the consistent UL LBT failure to the node to which the SCell belongs. In certain embodiments, the MAC CE can be used to report failure on the PCell.

In other words, in the case of consistent LBT failure, the UE 206 is allowed to autonomously switch the UL BWP. The motivation is that other UL BWP(s) of the NR-U cell may not be subject to large number of LBT failures, i.e., different LBT sub-bands 306 are used for different UL BWP(s).

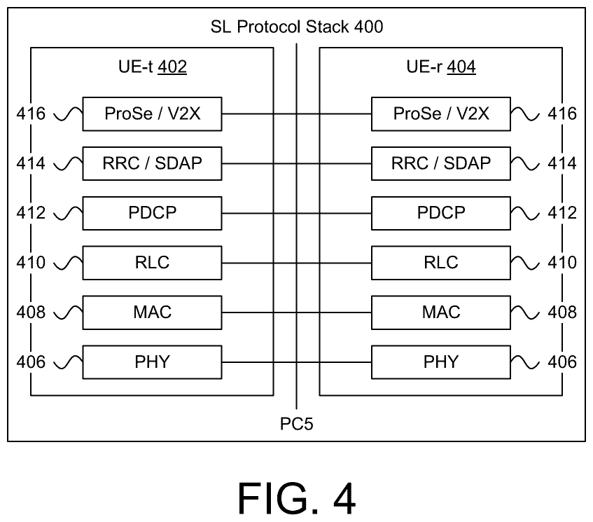

FIG. 4 illustrates a SL protocol stack 400, in accordance with aspects of the present disclosure. While FIG. 4 shows a UE-t 402 and a UE-r 404, these are representative of a set of UEs using SL communication over a PC5 interface; other embodiments may involve different SL UEs. In various embodiments, each of the UE-t 402 and a UE-r 404 may be an embodiment of the UE 104 and/or the UE 206.

As depicted, the SL protocol stack (i.e., PC5 protocol stack) includes a PHY layer 406, a MAC layer 408, a RLC layer 410, a PDCP layer 412, a SDAP layer (e.g., for the user plane), and an RRC layer (e.g., for the control plane). In FIG. 4, the SDAP layer and RRC layer are depicted as combined entity “RRC/SDAP layers” 414. There may be additional layers above the RRC/SDAP layers 414, such as a Proximity Services (“ProSe”) and/or V2X application layer 416.

The AS layer (also referred to as “AS protocol stack”) for the control plane in the PC5 interface consists of at least the RRC layer, the PDCP layer 412, the RLC layer 410, the MAC layer 408, and the PHY layer 406. The AS layer (also referred to as “AS protocol stack”) for the user plane in the PC5 interface consists of at least the SDAP layer, the PDCP layer 412, the RLC layer 410, the MAC layer 408, and the PHY layer 406.

Similar to the NR protocol stack, the L1 refers to the PHY layer 406. The L2 is split into the SDAP layer, the PDCP layer 412, the RLC layer 410, and the MAC layer 408. The L3 includes the RRC layer for the control plane and includes, e.g., an IP layer or PDU Layer (not depicted) for the user plane. L1 and L2 are generally referred to as “lower layers,” while L3 and above (e.g., transport layer, V2X layer, application layer) are referred to as “higher layers” or “upper layers.” The PHY layer 406, the MAC layer 408, the RLC layer 410, and the PDCP layer 412 perform similar functions as the PHY layer 212, the MAC sublayer 214, the RLC sublayer 216, and the PDCP sublayer 218, described above with reference to FIG. 2.

In various embodiments, the SL communication relates to one or more services requiring SL connectivity, such as V2X services and ProSe services. The UE-t 402 may establish one or more SL connections with nearby UE-r's 404. For example, a V2X application running on the UE-t 402 may generate data relating to a V2X service and use a SL connection to transmit the V2X data to one or more nearby UE-r's 404.

In NR-U, channel access in both downlink and uplink relies on the LBT procedure. The gNB and/or UE must first sense the channel to find out there are no ongoing communications prior to any transmission. When a communication channel is a wide bandwidth unlicensed carrier, the LBT/CCA procedure relies on detecting the energy level on multiple sub-bands of the communications channel as shown in FIG. 3. Note that no beamforming is considered for LBT in NR-U in Release 16 (Rel-16) and only omni-directional LBT is assumed.

In LBT, transmitters are expected to “sense” the medium, based on a Clear Channel Assessment (CCA) protocol, and detect transmissions from other nodes prior to transmitting. The simplest CCA method is energy detection, i.e., to measure the received energy level of signals transmitted from other devices and determine whether a channel is idle or busy.

Regarding SL operation in unlicensed spectrum, in Rel-16, sidelink communication was developed in RAN mainly to support advanced V2X applications. In Release 17 (Rel-17), Proximity-based service including public safety and commercial related service were standardized. As part of Rel-17, power saving solutions (e.g., partial sensing, discontinuous reception (DRX)) and inter-UE coordination were developed to improve power consumption for battery limited terminals and reliability of sidelink transmissions.

Although NR sidelink was initially developed for V2X applications, there is growing interest in the industry to expand the applicability of NR sidelink to commercial use cases. For commercial sidelink applications, two key requirements have been identified: 1) increased sidelink data rate, and 2) support of new carrier frequencies for sidelink.

Increased sidelink data rate is motivated by applications such as sensor information (video) sharing between vehicles with high degree of driving automation. Commercial use cases could require data rates in excess of what is possible in Rel-17. Increased data rate can be achieved with the support of sidelink carrier aggregation and sidelink over unlicensed spectrum. Furthermore, by enhancing the FR2 sidelink operation, increased data rate can be more efficiently supported on FR2. While the support of new carrier frequencies and larger bandwidths would also allow improvement to data rate, the main benefit would come from making sidelink more applicable for a wider range of applications. More specifically, with the support of unlicensed spectrum and the enhancement in FR2, sidelink will be in a better position to be implemented in commercial devices since utilization of the ITS band is limited to ITS safety related applications.

Various systems may support sidelink communication on unlicensed spectrum for both mode 1 and mode 2 where Uu operation for mode 1 is limited to licensed spectrum only. In certain embodiments, the channel access mechanisms from NR-U (discussed above with reference to FIG. 3) are reused for SL-U operation and the existing NR sidelink and NR-U channel structure are also reused, as the baseline, for SL-U operation. In other words, the SL devices perform LBT/CCA prior to occupying a channel on unlicensed spectrum.

In NR-U when the UE 206 detects consistent uplink LBT failures, it takes actions as specified in 3GPP TS 38.321 and described above. The detection is per Bandwidth Part (BWP) and based on all uplink transmissions within this BWP. For cases when sidelink is operated on a cell configured with, the corresponding UE actions upon detection of consistent LBT failures for sidelink transmissions on an RB set/RP need to be defined.

For SL unlicensed, once a consistent LBT failure has been declared, among others it results into a situation where a SL receiver device (i.e., the UE-r 404) may not be able to transmit HARQ feedback about a successful or failed reception to a corresponding SL transmitter device (i.e., the UE-t 402). In absence of multiple of such HARQ feedback(s), i.e., when sl-MaxNumConsecutiveDTX is reached, the UE-t 402 may deduce that the link between it and the UE-r 404 has met RLF for the NR sidelink communication transmission and the corresponding PC5-RRC connection is released.

As noted above, the existing mechanism of releasing and re-establishing the PC5-RRC connection will lead to data loss and negative user experience. The present disclosure described various solutions to allow for an efficient and reliable way around this situation.

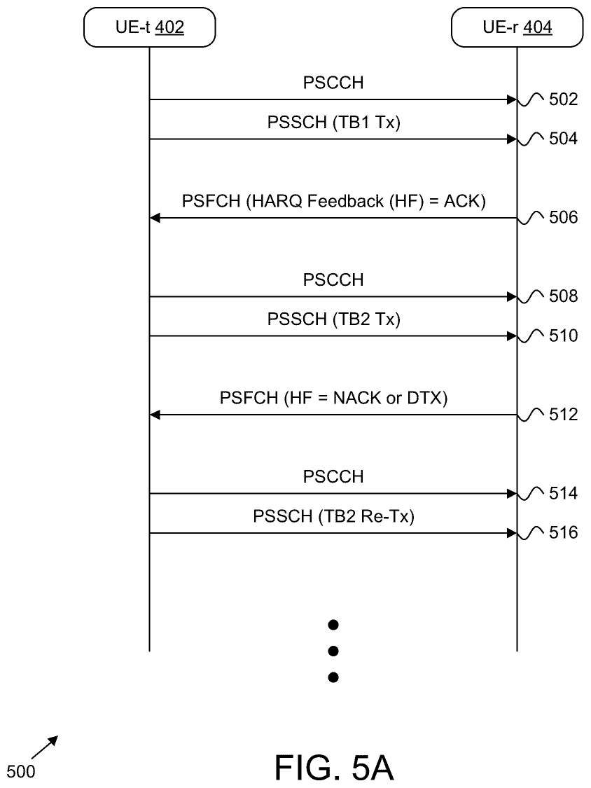

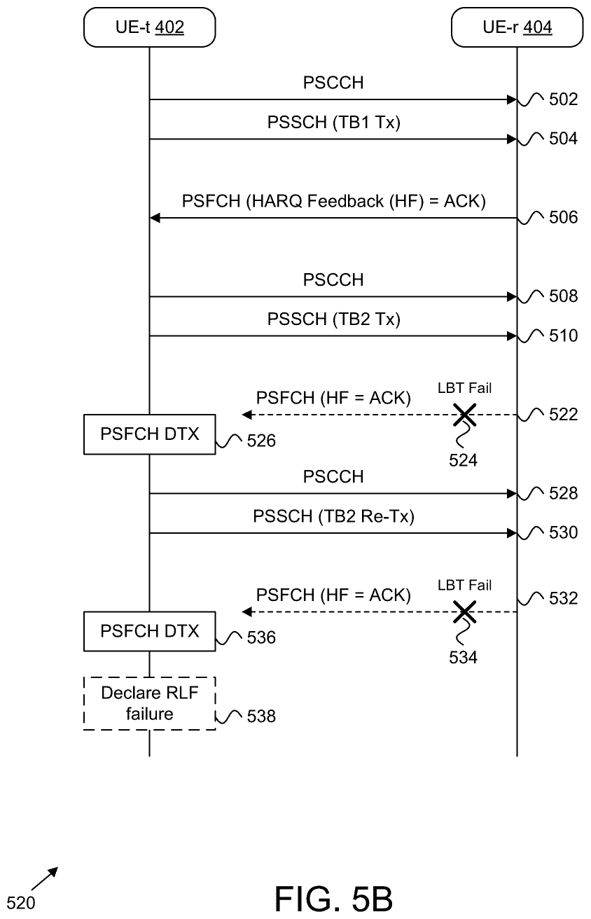

FIG. 5A illustrates an example of a SL communication procedure 500, in accordance with aspects of the present disclosure. The SL communication procedure 500 involves unicast transmissions between an embodiment of the UE-t 402 and the UE-r 404. In one embodiment, the SL communication procedure 500 may employ SL resources on licensed spectrum. In another embodiment, the SL communication procedure 500 employs SL resources on shared spectrum.

Note that in SL-U operation, the UE-t 402 must perform an LBT procedure prior to each Physical Sidelink Control Channel (PSCCH) and Physical Sidelink Shared Channel (PSSCH) transmission and transmits SL data and SL Control Information (SCI) to the UE-r 404 upon LBT success (i.e., when the CCA yields a positive result). Similarly, the UE-r 404 must perform an LBT procedure prior to each Physical Sidelink Feedback Channel (PSFCH) transmission and transmits HARQ feedback to the UE-t 402 upon LBT success (i.e., when the CCA yields a positive result). However, if the CCA yields a negative result (i.e., indicating the channel is occupied/busy), then the SL channel is unavailable for transmission and the transmitting device (e.g., UE-t 402 or UE-r 404) must wait for a new transmission opportunity (e.g., PSCCH, PSSCH, or PSFCH occasion) and again perform a LBT procedure.

The UE-t 402 transmits a data packet (denoted “TB1”) to the UE-r 404. Specifically, the UE-t 402 attempts to transmit to the UE-r 404 by transmitting SCI (e.g., stage 1 and stage 2) on the PSCCH (see transmission 502) and transmitting the data (i.e., TB1 transmission) on the PSSCH (see transmission 504). Note that the SCI may indicate a HARQ process identifier (HPID) of the TB1.

The UE-r 404 attempts to decode the data transmission (i.e., TB1) and generates HARQ feedback based on the decoding result. A positive acknowledgement (ACK) means that the Transport Block (TB) is correctly received while a negative acknowledgement (NACK) means that the TB is erroneously received. DTX means that no TB was detected by the receiver (i.e., UE-r 404). The UE-r 404 transmits the HARQ feedback to the UE-t 402 on a PSFCH occasion (see transmission 506).

If the UE-t 402 receives a HARQ ACK feedback from the UE-r 404 for the TB1, then the UE-t 402 will start transmission of new data (e.g., TB2) to the UE-r 404. Otherwise, when the UE-t 402 receives a HARQ NACK feedback from the UE-r 404—or does not receive any feedback (DTX) on the PSFCH, then the UE-t 402 attempts to retransmit the SL data (e.g., TB1) to the UE-r 404.

In the SL communication procedure 500, it is assumed that the UE-t 402 receives an ACK from the UE-r 404 in the PSFCH transmission 506. Accordingly, the UE-t 402 attempts to transmit SCI to the UE-r 404 on the PSCCH (see transmission 508) and to transmit the new data (i.e., TB2 transmission) to the UE-r 404 on the PSSCH (see transmission 510). Note that the SCI may indicate a HPID of the TB2.

Subsequently, the UE The UE-r 404 attempts to decode the new data (i.e., TB2), generates HARQ feedback based on the decoding result, and transmits the HARQ feedback to the UE-t 402 on a PSFCH occasion (see transmission 512). Here, it is assumed that the UE-t 402 receives a NACK or DTX from the UE-r 404 in the PSFCH transmission 506 or does not receive any feedback on the PSFCH.

Due to the NACK or DTX, the UE-t 402 attempts to retransmit the SL data (e.g., TB2) to the UE-r 404. To do so, the UE-t 402 attempts to transmit to the UE-r 404 by transmitting SCI on the PSCCH (see transmission 514) and retransmitting the data (i.e., TB2 retransmission) on the PSSCH (see transmission 516). Note that the SCI may indicate a HPID of the TB2.

Note that the UE-t 402 counts the consecutive number of DTXs. If these exceed a configured value of maximum DTX, then the UE-t 402 declares RLF and releases the PC5 RRC Connection.

FIG. 5B illustrates an example of a SL communication procedure 520 performed on unlicensed spectrum (i.e., shared spectrum), in accordance with aspects of the present disclosure. The SL communication procedure 520 involves unicast transmissions between an embodiment of the UE-t 402 and the UE-r 404.

Steps 502-510 occur as described above with reference to FIG. 5A. However, in the SL communication procedure 520 it is assumed that the UE-r 404 successfully decodes the TB2 received in PSSCH transmission 510 and generates ACK. Here, however, the UE-r 404 is unable to perform the PSFCH transmission 522 containing the HARQ feedback due to LBT failure 524 for the PSFCH occasion.

Therefore, the UE-t 402 determines a DTX instance for the PSFCH transmission corresponding to the initial transmission of TB2 (see block 526). Accordingly, the UE-t 402 attempts to retransmit the TB2 to the UE-r 404 by transmitting SCI on the PSCCH (see transmission 528) and retransmitting the data (i.e., TB2 retransmission) on the PSSCH (see transmission 530). However, in reality the retransmission of TB2 is unnecessary and the UE-t 402 wastes resources in performing the redundant transmissions 528 and 530.

In the SL communication procedure 520, it is further assumed that the UE-r 404 again is unable to perform the PSFCH transmission 532 containing the HARQ feedback due to LBT failure 534 for the PSFCH occasion. LBT failures are tracked/counted for an RB set on which the LBT/CCA failure happens. Because the LBT failure 534 prevents the PSFCH transmission 532, the UE-t 402 determines a DTX instance for the PSFCH transmission corresponding to the retransmission of TB2 (see block 536).

As noted above, the UE-t 402 counts the consecutive number of DTXs. If these exceed a configured value of maximum DTX, then the UE-t 402 declares RLF and releases the PC5 RRC Connection. In unlicensed operation even though the channel condition is quite good (calculated based on radio quality of discovery signals and/or other reference signals), the UE-r 404 may still be unable to transmit HARQ feedback on the PSFCH channel if the CCA (clear channel assessment) fails-referred to generally as “LBT failure”.

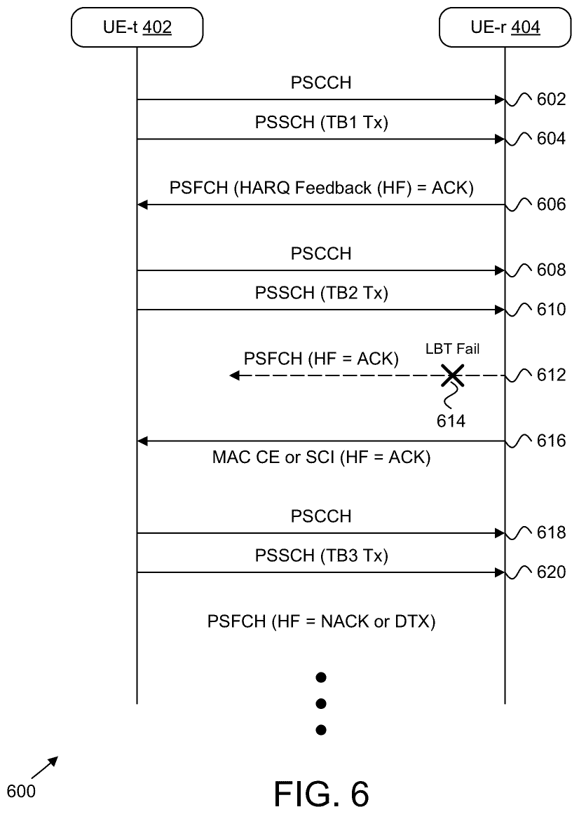

Therefore, it is possible that due to such consistent LBT failures, the UE-t 402 may declare RLF (see block 538) assuming that the radio channel is bad, and the UE-r 404 is not simply reachable. To mitigate this, the UE-r 404 may perform a new transmission on different SL resources as described below with reference to FIG. 6.

FIG. 6 illustrates an example of a SL communication procedure 600 performed on unlicensed spectrum (i.e., shared spectrum), in accordance with aspects of the present disclosure. The SL communication procedure 600 involves unicast transmissions between an embodiment of the UE-t 402 and the UE-r 404.

The UE-t 402 attempts to transmit a data packet (denoted “TB1”) to the UE-r 404 by transmitting SCI (e.g., stage 1 and stage2) on the PSCCH (see transmission 602) and transmitting the data (i.e., TB1 transmission) on the PSSCH (see transmission 604). Note that the SCI may indicate a HPID of the TB1.

The UE-r 404 attempts to decode the data transmission (i.e., TB1) and generates HARQ feedback based on the decoding result. Here, it is assumed that TB1 is successfully received at the UE-r 404. The UE-r 404 transmits the HARQ feedback (i.e., ACK) to the UE-t 402 on a PSFCH occasion (see transmission 606).

It is assumed that the UE-t 402 receives the ACK from the UE-r 404 in the PSFCH transmission 506. Accordingly, the UE-t 402 attempts to transmit a new data packet (denoted “TB2”) to the UE-r 404 by transmitting SCI on the PSCCH (see transmission 608) and transmitting the data (i.e., TB2 transmission) on the PSSCH (see transmission 610). Note that the SCI may indicate a HPID of the TB2.

In the SL communication procedure 600 it is assumed that the UE-r 404 successfully decodes the TB2 received in PSSCH transmission 610 and generates ACK. Here, however, the UE-r 404 is unable to perform the PSFCH transmission 612 containing the HARQ feedback due to LBT failure 614 for the PSFCH occasion.

In response to one or more criteria being met, the UE-r 404 attempts to transmit a new message to the UE-t 402 by transmitting a MAC CE or SCI (see transmission 616) using different resources than those associated with the LBT failure 614. The contents of this new message and various criteria for triggering this new transmission are described in the below solutions. Beneficially, this new transmission allows the UE-t 402 to receive the HARQ feedback and avoid the flawed RLF declaration in FIG. 5B.

Accordingly, the UE-t 402 attempts to transmit a new data packet (denoted “TB3”) to the UE-r 404 by transmitting SCI on the PSCCH (see transmission 618) and transmitting the data (i.e., TB3 transmission) on the PSSCH (see transmission 620). Note that the SCI may indicate a HPID of the TB3.

According to aspects of a first solution, the UE-r 404 can mitigate the PSFCH DTX determination and/or avoid the flawed RLF declaration at the UE-t 402 by maintaining one or more counters for PSFCH LBT failure. In some embodiments, after attempting HARQ feedback transmission and receiving an LBT failure from lower layer, the UE-r 404 increments a counter, denoted PSFCH_LBT_Failed_COUNT. In certain embodiments, the counter PSFCH_LBT_Failed_COUNT is maintained per source-destination pair and per RB set.

If the SL operation uses multiple PSFCH occasions (i.e., if the parameter multiple PSFCH occasions is configured) and the UE-r 404 receives LBT failure for each of these occasions from the lower layers (i.e., from the MAC layer 408 and/or the PHY layer 406), then the UE-r 404 increments the counter PSFCH_LBT_Failed_COUNT for each LBT failure instance, i.e., once for each failure indication on a corresponding RB set (e.g., of the PSFCH occasions configured across RB sets).

Regarding triggering criteria, in a first implementation of the first solution, the UE-r 404 determines first if a continuous LBT failure condition of the PSFCH (denoted “PSFCH-C-LBT failure”) occurs, which happens if PSFCH_LBT_Failed_COUNT reaches a threshold (denoted “Thresh_1”) within a time period. Thresh_1 can be PC5 RRC configured, or (pre) configured by the serving cell of the sidelink device.

After having determined a PSFCH-C-LBT failure, the UE-r 404 initiates a new transmission to the UE-t 402, i.e., to the destination corresponding to the one for which the PSFCH_LBT_Failed_COUNT is maintained by the UE-r 404.

In certain embodiments, the time period can be specified, or left for UE implementation, or can be (pre) configured by the serving radio network to the UE as a timer value. In one embodiment, the timer is started (i.e., when it is not already running) for a corresponding destination (e.g., the UE-t 402) when the first LBT failure (failed CCA) for the corresponding destination occurs, i.e., when an LBT failure indication has been received from lower layers in the UE-r 404.

In certain embodiments, the counter PSFCH_LBT_Failed_COUNT is reset to ‘0’ when the timer expires.

In a second implementation of the first solution, in addition to the behavior of the first implementation, the counter PSFCH_LBT_Failed_COUNT is reset to ‘0’ and the corresponding timer is stopped and/or reset once a PSFCH is successfully transmitted to the corresponding destination.

In a variation of this implementation, the counter PSFCH_LBT_Failed_COUNT is decreased (by a value of 1 or more) whenever a PSFCH is successfully transmitted to the corresponding destination. Again, the counter may be reset to ‘0’ when the timer expires.

Further, as in the first implementation, the UE-r 404 determines whether a PSFCH-C-LBT failure occurs, i.e., which happens if PSFCH_LBT_Failed_COUNT reaches a Thresh_1 within a time period. After having determined a PSFCH-C-LBT failure, the UE-r 404 initiates a new transmission to the UE-t 402, i.e., to the destination corresponding to the one for which the PSFCH_LBT_Failed_COUNT is maintained by the UE-r 404.

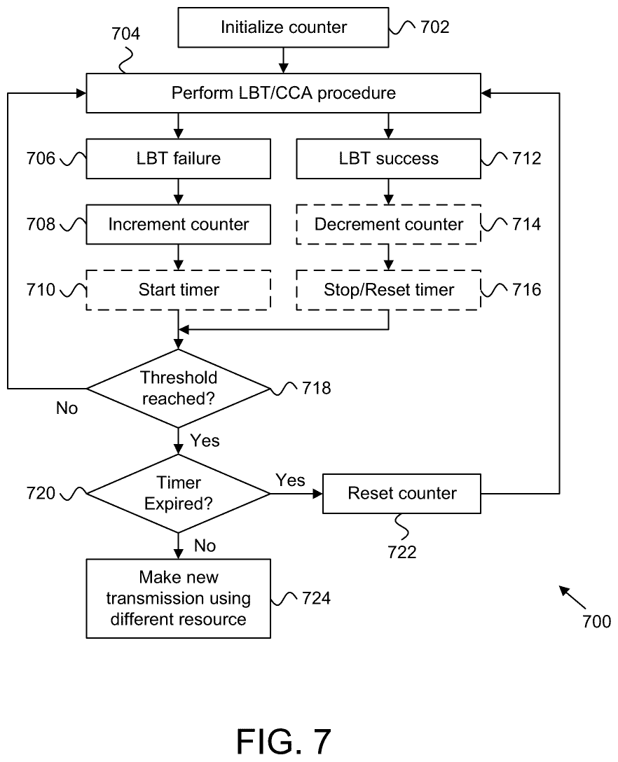

FIG. 7 illustrates a procedure 700 for performing a new transmission in response to PSFCH-C-LBT failure, in accordance with aspects of the present disclosure. The procedure 700 may be performed by an embodiment of the UE-r 404.

The UE-r 404 initializes a counter (see block 702), such as the counter PSFCH_LBT_Failed_COUNT described herein, and the UE-r 404 performs a LBT/CCA procedure, e.g., for a PSFCH transmission (see block 704).

If the LBT/CCA procedure yields a negative result (i.e., LBT failure, see block 706), then the UE-r 404 increments the counter (see block 708) and may optionally start a timer (if not already running, see block 710). Here, a LBT failure indication may be received from lower layers in the UE-r 404.

Otherwise, if the LBT/CCA procedure yields a positive result (i.e., LBT success, see block 712), then the UE-r 404 decrements the counter (see block 714) and may optionally stop and/or reset the timer (see block 716).

The UE-r 404 determines whether the counter reaches a threshold value (see block 718). If not reached, the UE-r 404 may monitor for a subsequent LBT/CCA procedure. Otherwise, if the threshold is reached, then the UE-r 404 determines whether the timer is expired (see block 720).

If the timer is expired, the UE-r 404 resets the counter (see block 722) and monitors for a subsequent LBT/CCA procedure. Otherwise, if the threshold is reached and the timer is not expired, then the UE-r 404 makes a new transmission using a different resource, e.g., a new RB set (see block 724).

Different implementations for realizing the new transmission are possible. In one implementation, the new transmission is a new MAC CE. In another implementation, the new transmission is a SCI transmission.

In various embodiments, the new transmission is a new MAC CE which is identified by a MAC subheader with specific Logical Channel Identifeir (LCID). The new MAC CE is transmitted on a different and available RB set, e.g., it triggers a resource selection at the UE-r 404 to avoid using the same RB set for which LBT has failed consistently.

In various embodiments, the MAC CE contains a combination of one or more following elements: A) RB Set identification where PSFCH-C-LBT failure occurred; B) Resource Pool identification where PSFCH-C-LBT failure occurred; C) Recommended RB Set identification; D) Recommended Resource Pool identification; E) HPIDs (if there are consistent PSFCH-related LBT failures for multiple TBs) for TBs which the UE-r failed to decode successfully. The included HPID is same as the one received in SCI format 2-A/SCI format 2-B by the UE-r 404; F) HARQ Feedback(s)—this is like one shot HARQ feedback for all TBs for which feedback could not be transmitted or for which the data is not yet successfully decoded by the UE-r 404; G) No payload.

In the case of no payload, the MAC CE just contains a subheader. Upon receiving this, a transmitter UE (i.e., UE-t 402) is to perform retransmission and/or transmission repetition of all pending TBs to the receiver UE i.e., any TB for which a HARQ ACK has not yet been received by the UE-t from UE-r. In certain embodiments, retransmission or transmission repetition can be done on the RB set where the MAC CE is received. As used herein, the notation “retransmit/repeat” or “retransmits/repeats” indicates the performing of a retransmission and/or a transmission repetition.

As used herein, a retransmission refers to the case where the transmitter (i.e., UE-t 402) sends the same TB again using HARQ retransmission e.g., with a different redundancy version.

In one enhancement, the MAC CE may include a triggering condition flag, e.g., was the MAC CE triggered because of the counter PSFCH_LBT_Failed_COUNT reaching the threshold or the counter rbSet_LBT_Failed_COUNT reaching the threshold.

In one implementation, the MAC CE has a fixed size and contains only one (or more) of the above elements—which is specified. In another implementation, the MAC CE has a variable size and contains one or more optional elements with its corresponding ‘presence’ field in the MAC CE subheader indicating if the particular element is included (or not). As one particular implementation, the new MAC CE has no payload and contains just a subheader.

In one enhancement to ensure transmission of MAC CE, the priority (e.g., Logical Channel (LCH) Priority and/or L1 transmission priority) is considered to be the highest for the MAC CE corresponding to the new transmission described previously. This affects destination selection during the MAC Logical Channel Prioritization (LCP) procedure and ensures that the MAC CE is always transmitted whenever a transmission grant is available at the UE-r 404. If there is more than one UE-t for which the MAC CEs need to be transmitted when a SL grant becomes available, then the UE-r 404 transmits MAC CE to a respective UE-t for which the MAC CE transmission was triggered earliest.

In various embodiments, the new transmission may be a new SCI in an existing SCI format, or a new SCI format containing one or more of the above elements, as described previously for the new MAC CE implementations. For example, the new SCI format may be called SCI format 2-C and contain one or more of the above fields. Alternatively, a combination of the above elements may be sent using reserved bits of the SCI format 1-A.

Note that SCI format 1-A, as defined by 3GPP, is used for the scheduling of PSSCH and 2^{nd}-stage-SCI on PSSCH. The following information is transmitted by means of the SCI format 1-A: Priority; Frequency resource assignment; Time resource assignment; Resource reservation period; Demodulation Reference Signal (DMRS) pattern; 2^{nd}-stage SCI format; Beta_offset indicator; Number of DMRS ports; Modulation and coding scheme; Additional MCS table indicator; PSFCH overhead indication; and Reserved Bits. These information are defined below:

Priority is a 3 bit field, e.g., as specified in clause 5.4.3.3 of 3GPP TS 23.287 and clause 5.22.1.3.1 of 3GPP TS 38.321.

Frequency resource assignment is a variable length field, as defined in clause 8.1.5 of 3GPP TS 38.214. When the value of the higher layer parameter sl-MaxNumPerReserve is configured to 2, then this field has a length of

$$⌈ {log}_{2} ( \frac{{N}_{subChannel}^{SL} ( {N}_{subChannel}^{SL} + 1 )}{2} ) ⌉$$

bits. Otherwise, when the value of the higher layer parameter sl-MaxNumPerReserve is configured to 3, this field has a length of

$$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉$$

bits.

Time resource assignment is a variable length field, as defined in clause 8.1.5 of 3GPP TS 38.214. When the value of the higher layer parameter sl-MaxNumPerReserve is configured to 2, this field has a length of 5 bits. Otherwise, when the value of the higher layer parameter sl-MaxNumPerReserve is configured to 3, this field has a length of 9 bits.

Resource reservation period has a length of [log₂ N_{rsv_period}] bits as defined in clause 16.4 of 3GPP TS 38.213, where N_{rsv_period} is the number of entries in the higher layer parameter sl-ResourceReservePeriodList, if higher layer parameter sl-MultiReserveResource is configured; 0 bit otherwise.

DMRS pattern has a length of [log₂ Nₚₐₜₜₑᵣₙ] bits as defined in clause 8.4.1.1.2 of 3GPP TS 38.211, where Nₚₐₜₜₑᵣₙ is the number of DMRS patterns configured by higher layer parameter sl-PSSCH-DMRS-TimePatternList.

The 2^{nd}-stage SCI format field has a length of 2 bits, as defined in Table 8.3.1.1-1 of 3GPP TS 38.211.

Beta_offset indicator is a 2 bit field as provided by higher layer parameter sl-BetaOffsets2ndSCI and Table 8.3.1.1-2 of 3GPP TS 38.211.

Number of DMRS port is a 1 bit field as defined in Table 8.3.1.1-3 of 3GPP TS 38.211.

Modulation and coding scheme is a 5 bit field as defined in clause 8.1.3 of 3GPP TS 38.214.

Additional MCS table indicator is a variable length field, as defined in clause 8.1.3.1 of 3GPP TS 38.214: this field has a length of 1 bit if one MCS table is configured by higher layer parameter sl-Additional-MCS-Table; 2 bits if two MCS tables are configured by higher layer parameter sl-Additional-MCS-Table; 0 bit otherwise.

PSFCH overhead indication is a 1 bit field as defined clause 8.1.3.2 of 3GPP TS 38.214, if higher layer parameter sl-PSFCH-Period=2 or 4; 0 bit otherwise.

The number of Reserved bits is determined by higher layer parameter sl-NumReservedBits, with value set to zero.

Referring again to the new transmission of SCI to indicate HARQ feedback and/or LBT failure information, for the ‘no payload’ elements as revealed previously for the new MAC CE, the SCI transmission needs to carry 1 bit to indicate this situation e.g., a Boolean flag indicating to the UE-t 402 to retransmit/repeat all pending TBs to the UE-r 404, i.e., retransmit/repeat any TB for which a HARQ ACK has not yet been received by the UE-t 402 from the UE-r 404.

The retransmit/repeat can be done on the RB set where the SCI is received. To achieve this, the UE-r 404 may just indicate one bit basically asking the UE-t 402 to change the transmission RB set (in that case the UE-t 402 should ideally use the same RB-set where it received the MAC CE), or an identification of good/bad RB sets but no details about “which TBs”. In this case, the UE-t 402 retransmits all pending TBs i.e., TBs for which it has not yet received a HARQ ACK.

The SCI (a new SCI format or existing SCI containing new element(s)) may or may not schedule a PSSCH and may implicitly (e.g., when no valid Frequency/Time resource assignment is included) or explicitly indicate if a PSSCH is scheduled or not.

According to aspects of a second solution, in addition to the counter PSFCH_LBT_Failed_COUNT from the first solution, the UE-r 404 also maintains another per RB set LBT failure counter (denoted “rbSet_LBT_Failed_COUNT”), i.e., not per source-destination (SRC-DST) pair. Here, the counter rbSet_LBT_Failed_COUNT tracks all transmission failures due to LBT failures on the RB set within a time period, i.e., due to PSCCH/PSSCH, PSFCH, or Synchronization Signal Block (SSB) and/or System Information Block (SIB) transmission failures.

With respect to the PSFCH-related LBT failure, unlike the counter PSFCH_LBT_Failed_COUNT, the counter rbSet_LBT_Failed_COUNT is increased only once for a HARQ feedback transmission failure originating from the same TB feedback even if multiple PSFCH occasions are configured. In another variant, instead of the multiple PSFCH occasions being configured, the multiple/additional PSFCH occasions could be dynamically triggered.

In a first implementation of the second solution, if PSFCH_LBT_Failed_COUNT reaches a first threshold (i.e., Thresh_1) and the counter rbSet_LBT_Failed_COUNT reaches a second threshold (denoted “Thresh_2”), then the UE-r 404 initiates transmission of the MAC CE (or SCI information) as described in the first solution to a destination (i.e., UE-t 402) corresponding to the one for which the PSFCH_LBT_Failed_COUNT is maintained by the UE-r 404.

In a second implementation of the second solution, when the counter rbSet_LBT_Failed_COUNT reaches a Thresh_3, the UE-r initiates transmission of the MAC CE (or SCI information) as described in the first solution to any sidelink peer UE which is transmitting data to the UE-r 404, e.g., warning that data transmissions to the UE-r 404 requesting HARQ feedback on the PSFCH channel should not be made on indicated RB set(s).

In response to receiving this information from the UE-r 404, a UE-t 402 may only transmit data without requesting corresponding HARQ feedback on the problematic RB set. Alternatively, the UE-t 402 may use another non-problematic RB set for data transmission to the UE-r 404 in response to receiving this information.

Alternatively, UE-r may maintain rbSet_LBT_Failed_COUNT on a per destination (DST) UE basis and count against to see if the individual counter per destination reaches the Thresh_3.

In certain implementations, there may be two different timer values configured for the PSFCH_LBT_Failed_COUNT and the rbSet_LBT_Failed_COUNT. In other implementations, the same configuration/value applies to both rbSet_LBT_Failed_COUNT and PSFCH_LBT_Failed_COUNT.

In some implementations, a network may configure (or preconfigure) a lower value for PSFCH_LBT_Failed_COUNT compared with the value sidelink Max Num Consecutive DTX (sl-MaxNumConsecutiveDTX in 3GPP TS 38.331) to ensure that the UE-r 404 can inform and request the UE-t 402 to switch to another RB set before the UE-t 402 would declare RLF.

As another enhancement of the second solution, reception of a new transmission (e.g., MAC CE) resets the local counter at UE-t 402 for sidelink Max Num Consecutive DTX (sl-MaxNumConsecutiveDTX in 3GPP TS 38.331) to value ‘0’.

According to aspects of a third solution, the UE-r 404 uses two counters to alert peer sidelink UEs. A peer UE is one from which the UE-r 404 has received data, or is expecting to receive data e.g., one to which the data has been/or being transmitted. Using the alert (i.e., the new transmission described in the previous solutions), the peer UE will update its DTX counter and can refrain from using specific problematic RB set(s) for further (re) transmission, as follows:

Two types of counters are used: a common counter and a destination-specific counter. The common counter (denoted “common-counter”) is used to count CCA/LBT failures for any kind of transmission for all/any destinations. The destination-specific counter (denoted “destination-specific-counter”) is used to count CCA/LBT failures for any kind of transmission (data, destination specific control/reference signals) to that particular destination. The common-counter may have a (pre) configured value higher than the destination-specific-counter.

As an example, if there are say ‘n’ peer UEs for a UE-r 404, then the UE-r 404 is running a LBT failure detection and recovery procedure (e.g., as defined in clause 5.21.2 of 3GPP TS 38.321) ‘n+1’ times, i.e., once for each of the ‘n’ peer UEs to monitor destination-specific-counter and a common one (common-counter) for all the peers together.

When the destination-specific-counter has reached a threshold value (denoted “Thresh_4”), the UE-r 404 sends the new transmission (i.e., described above with reference to the first solution) to the corresponding UE and when/if common-counter has reached another threshold value (similar to lbt-FailureInstanceMaxCount described in 3GPP TS 38.331), the UE-r 404 sends the previously described new transmission to all peer UEs. Alternatively, the UE-r 404 sends the new transmission only to those peer UEs that have not already been sent the new transmission, i.e., because their destination-specific-counter has not reached the threshold value (i.e., Thresh_4).

In various embodiments, the supervision for the counting procedure uses the same timer mechanism as described earlier. In one embodiment, there may be two different timer values configured for the first and second counters. In another embodiment, the same timer configuration/value applies to both the first and second counters. To enable transmission of the new transmission, the respective counter(s) need to reach the threshold value within a certain time period. The counters are reset to ‘0’ when the corresponding timer expires.

As described above, the time period can be specified, left for UE implementation, or can be (pre) configured by the serving radio network to the UE as a timer value. In one embodiment, the destination-specific-counter related timer is started (i.e., if it is not already running) when the first LBT failure (failed CCA) occurs for a corresponding peer UE (i.e., when LBT failure indication has been received from lower layers in the UE-r 404).

In certain embodiments, the thresholds Thresh_1, Thresh_2, Thresh_3, and Thresh_4 can be configured by a peer UE, e.g., using PC5-RRC signaling. Alternatively, these threshold may be preconfigured or configured by the serving cell of the sidelink device. In various embodiments, the thresholds are integers, and their values may start from ‘0’.

According to aspects of a fourth solution, the new transmission (e.g., MAC CE or SCI) sent by the UE-r 404 contains feedback information about recently attempted receptions. This can be done in a number of ways.

In one implementation, the UE-r 404 can inform the UE-t 402 of all TBs successfully decoded but for which the HARQ ACK could not be transmitted, e.g., due to CCA/LBT failure. Upon receiving this information, the UE-t 402 clears its L2 buffer(s) for the TBs indicated as successfully decoded and retransmits/repeats other TBs not yet acknowledged by the UE-r 404. In one embodiment, the retransmit/repeat can be done on the (non-problematic) RB set, e.g., where the feedback information is received.

In another implementation, the UE-r 404 can inform the UE-t 402 of all TBs which it failed to decode correctly and for which the HARQ NACK could not be transmitted, e.g., due to CCA/LBT failure. Upon receiving this information, the UE-t 402 clears its L2 buffer(s) for the TBs indicated implicitly as successfully decoded and retransmits/repeats other TBs not yet positively acknowledged by the UE-r 404. In one embodiment, the retransmit/repeat can be done on the (non-problematic) TB set e.g., where the feedback information is received.

To achieve this, if there are consistent PSFCH-related LBT failures for multiple TBs, the UE-r 404 feedback may contain the HARQ process identifiers (HPIDs) for those TBs which the UE-r 404 failed to decode successfully. The included HPID is same as the one received by the UE-r 404 in SCI format 2-A/SCI format 2-B.

Additionally, and/or alternatively, the feedback from the UE-r 404 may include aggregated HARQ Feedback(s) (e.g., like one-shot HARQ feedback) for all TBs for which feedback could not be transmitted or for which the data is not yet successfully decoded by the UE-r 404. An example of the aggregated HARQ feedback(s) is depicted in Table 1.

TABLE 1
Aggregated HARQ feedback(s)

| | |
|---|---|
| HPID_1 | ACK |
| HPID_2 | NACK |
| . . . | . . . |
| HPID_n | ACK |

In another implementation, the RLC status reporting (e.g., as described in TS 38.322) can be used by the UE-r 404 to inform the UE-t 402 of the RLC PDUs successfully received or not-received. The UE-t 402 can then use this information for retransmission of the RLC PDUs not yet positively acknowledged by the UE-r 404.

According to aspects of a fifth solution, instead of using HARQ Process IDs, a transmitter UE includes a Sequence number (SN) of fixed ‘n’ bits in the SCI. The SN can be included in an existing SCI format, or a new SCI format. The new SCI format may be called SCI format 2-C and apart from the SN, contain some parameters from SCI format 2-A and/or SCI format 2-B, e.g., as listed in 3GPP TS 38.212 (v16.4.0). Alternatively, SN can also be included using some reserved bits of format 1-A. When the SN reaches the final value (e.g., 7 when using a 3-bit SN of 0-7), it wraps around. The SN count basically designates the TB number transmitted using the corresponding PSSCH (data) channel.

The SN is used in the UE-r 404 to note down for which TBs it was unable to transmit a generated HARQ feedback (e.g., due to CCA/LBT failure) and then includes the SN(s) in a MAC CE described previously to the transmitter. The UE-t 402 uses this information to make retransmissions/repetitions of the TB(s) which are indicated as not received successfully be the UE-r 404 and to clear/flush/release HARQ/L2 buffer for other TBs indicated as received successfully. The UE-r 404 may include a success/fail status for each of the last ‘n’ SNs. Accordingly, the SN length needs to be long enough to avoid having overlap among TBs in transmission.

According to aspects of a sixth solution, the UE-r 404 determines “LBT statistics” based on which it further determines whether or not to send a MAC CE (or SCI) when a CCA/LBT failure prohibits transmission of a particular HARQ Feedback. The MAC CE content (or SCI) is same as described in the previous solutions.

If a particular LBT statistical parameter exceeds (or alternatively, falls below) a (pre) configured threshold, a MAC CE is sent either to a specific UE-t 402, for which the LBT statistical parameter meets triggering condition; or to all UEs. The LBT statistics can be derived as a ratio of various factors as described in the following:

In certain embodiments, the LBT statistics can be derived as a ratio of the generated HARQ ACK (factor-1) to the generated NACK feedbacks (factor-2) ratio within past ‘n’ milliseconds/slots/reception attempts.

In certain embodiments, the LBT statistics can be derived as a ratio of the generated and successfully transmitted HARQ feedbacks (factor-3) to the generated but not successfully transmitted HARQ feedbacks (factor-4) ratio within past ‘n’ milliseconds/slots/reception attempts. In one implementation, only the CCA/LBT failure related non-transmission of the generated HARQ feedback is considered.

In a further implementation, factor-3 (generated and successfully transmitted HARQ feedbacks) or factor-4 (generated but not successfully transmitted HARQ feedbacks) could be further (and independently) restricted to take only ACK or only NACK into account. According to one example, factor-3 represents the “generated and successfully transmitted ACK feedback”. According to another example, factor-3 represents the “generated and successfully transmitted NACK feedback”. According to yet another example, factor-4 represents the “generated but NOT successfully transmitted ACK feedback”. According to a further example, factor-4 represents the “generated but NOT successfully transmitted NACK feedback”.

In an alternative implementation, factor-4 could represent any generated HARQ feedback (irrelevant whether successfully transmitted or not). Here, factor-4 could be further restricted to take into account only ACK or only NACK. According to one example, factor-4 represents “any generated ACK feedback”. According to another example, factor-4 represents “any generated NACK feedback”.

In other embodiments, the LBT statistics may be derived as any other ratio including the above factors. In one example, the ratio can be factor-1/factor-3. In another example, the ratio can be ‘factor-1/factor-4’. In yet other examples, the ratio can be ‘factor-3/(factor-1+factor2)’, etc.

Aspects of the seventh solution describe the behavior of the UE-t 402 upon receiving the new transmission from the UE-r 404. In various embodiments, the UE-t 402 may do one or more of the following in response to the new transmission: A) Make (re) transmissions/repetitions for failed or pending transmission on a RB set different from the ones indicated as problematic by the UE-r 404 (i.e., different from where PSFCH LBT failures occurred); B) Make (re) transmissions/repetitions for failed or pending transmission on the same problematic RB set as used previously but without requesting HARQ feedback; C) Make new transmissions on a different RB set; D) Report the content of the received new transmission e.g., the corresponding RB set to gNB in case a Uu link is available (e.g., for future Mode 1 scheduling); E) Reset numConsecutiveDTX to 0; F) (alternatively) Reduce numConsecutiveDTX by ‘n’, where ‘n’ is the number of PSFCH DTX(s) associated with the UE from which the new transmission is received.

The above behavior affects the resource selection procedure at UE-t 402. Until the time a certain RB set is considered not usable towards a destination UE (e.g., the UE-r 404), the UE-t 402 shall not consider the resources for resource (re) selection towards the destination UE.

In an alternative implementation of the seventh solution, the behaviors A, B, C, and E and the affected resource selection procedure as described earlier for the transmitter UE (i.e., UE-t 402) are applicable to and applied by a network element transmitter, e.g., base station or gNB.

Aspects of the eighth solution describe the RLF detection condition of a sidelink UE (e.g., UE-t 402) when using unlicensed spectrum. In one implementation, the network (e.g., RAN) configures one counter for sidelink maximum number of consecutive DTX (sl-MaxNumConsecutiveDTX). However, before reaching the completion of as many DTX (i.e., upon reaching an intermediate threshold), the UE-t 402 performs a resource (re) selection for which it chooses resources from a combination of another RB set, resource pool and carrier frequency for further (re) transmissions. If the UE-t 402 still receives DTX on PSFCH and the local counter reaches a value sl-MaxNumConsecutiveDTX, RLF is declared.

In another implementation of the eighth solution, using another configured counter value (total_DTX) that is maintained per Peer (e.g., receiver UE), the UE-t 402 counts total number of PSFCH DTXs for transmissions across RB Sets, resource pools and carriers and declares RLF only if the local counter reaches a value total_DTX.

According to aspects of a ninth solution, the UE-t 402 speculates why a PSFCH may not have been received by the UE-t 402 (or, conversely, why it may not have been transmitted by the UE-r 404) upon not receiving an expected PSFCH and, based on this speculation, the UE-t 402 manages the running DTX counter. Accordingly, the UE-t 402 may to determine if an absence of PSFCH may occur due to either radio link issues other than LBT issues and/or de-prioritization and/or pre-emption at the UE-r 404 (denoted “Case-1”), or due to LBT failure at the UE-r 404 (denoted “Case-2”).

For example, de-prioritization at the UE-r 404 may result in the PSFCH transmission being de-prioritized (e.g., sacrificed) to make another transmission. This could typically be the case if the UE-t 402 initiated Channel Occupancy Time (COT) sharing with the UE-r 404 allowing the UE-r 404 to only perform Type 2 channel access (16/25 μs). As another example, LBT failure may be indicated when no COT was initiated by the UE-t 402.

Regarding DTX Counter management at the UE-t 402, in Case-1, the UE-t 402 will increment the local DTX counter, whereas in Case-2, the UE-t 402 would not increment the local DTX counter. The DTX counter management affects the RLF declaration, as described previously and in accordance with HARQ-based Sidelink RLF detection procedure described in 3GPP TS 38.321, clause 5.22.1.3.3.

According to aspects of a tenth solution, the UE-t 402 and UE-r 404 may reuse a problematic RB set (i.e., one where PSFCH-C-LBT occurs) when certain conditions are met.

In one implementation, the UE-r 404 sends an update transmission (or revocation of the new transmission) to UE-t 402 indicating that the original RB Set may be used again (e.g., because consistent LBT failures are not occurring anymore or received signal strength indicator (RSSI) is below a certain network con (pre) configured radio threshold). Here, the update/revocation transmission could be a MAC CE or a SCI transmission.

In one implementation, the update/revocation transmission could be the same as the one sent for indicating the problem in the previous solutions with a Boolean flag indicating if the included RB Set has problem (Flag=True) or problem is revoked (Flag=False).

In another implementation, both the UE-r 404 and the UE-t 402 (or at least UE-t 402) assume that the RB set indicated as problematic earlier remains problematic/not-usable between these UEs until the expiry of certain (pre) configurable timer. For example, the UE-r 404 may start this timer upon transmission of the new transmission (e.g., MAC CE or SCI) and/or UE-t 402 may start the timer upon receiving the new transmission (e.g., MAC CE or SCI) from the UE-r 404.

In one variation, the update/revocation transmission could be a new/different MAC CE, optionally including information on the RB sets for which the problematic condition persists. If no RB set information is included in this MAC CE, then upon receiving the update/revocation transmission, the UE-t 402 will conclude that all RB Set(s) (alternatively: RB Set(s) previously reported as having the problematic condition) are good and can be used for transmission to the UE-r 404.

In another variation of the tenth solution, the RB set reuse indication is carried in as a new SCI information in an existing SCI format, or a new SCI format is used.

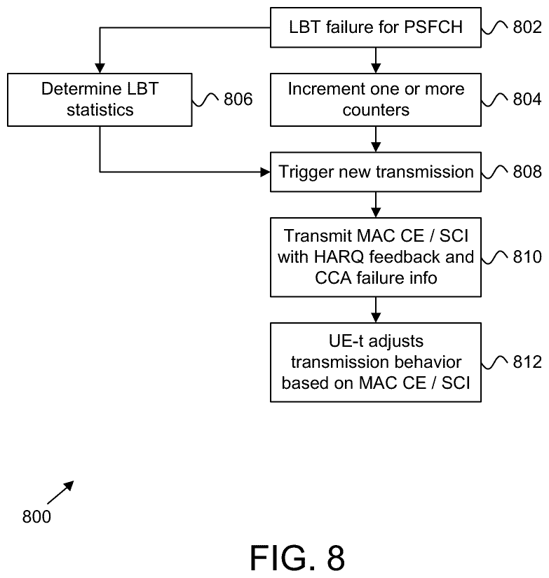

FIG. 8 illustrates a procedure 800 for mitigating consistent LBT failure, indicating the overall flow of the solutions described above. At block 802, the UE-r 404 experiences LBT failure, e.g., when attempting to perform a PSFCH transmission on unlicensed spectrum.

At block 804, the UE-r 404 increments one or more counters when PSFCH transmission fails, e.g., due to LBT failure. Various aspects of tracking LBT failure with one or more counters are described above with reference to the first, second, and third solutions.

At block 806, as an alternative to the use of one or more counters, the UE-r 404 may instead determine LBT statistics. Aspects of determining the LBT statistics are described above with reference to the sixth solution.

At block 808, the UE-r 404 triggers a new transmission due to consistent LBT failure. When using counters, the new transmission is triggered when at least one counter reaches a threshold amount, e.g., prior to expiry of a timer. When using LBT statistics, the new transmission is triggered when at least one LBT statistical parameter (e.g., a ratio of factors) reaches a threshold.

At block 810, the UE-r 404 makes the new transmission to the UE-t 402, e.g., by transmitting a MAC CE or SCI. The new transmission may include HARQ feedback and/or may include CCA failure information. Aspects of the new transmission are described above with reference to the first, fourth and fifth solutions.

At block 812, the UE-t 402 adjusts its transmission behavior based on the received new transmission, e.g., MAC CE or SCI. Aspects of determining the LBT statistics are described above with reference to the seventh, eighth, and ninth solutions.

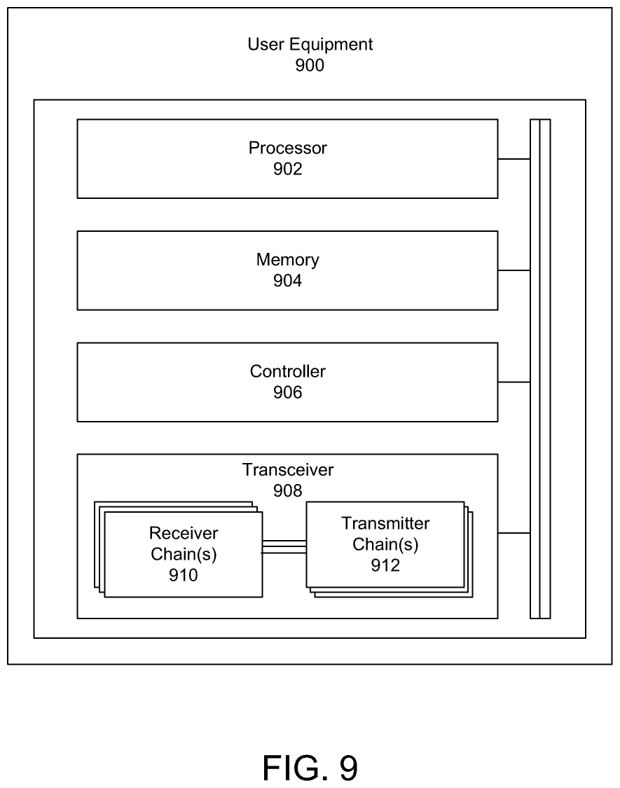

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a central processing unit (CPU), an ASIC, a field programmable gate array (FPGA), or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions that, when executed by the processor 902, cause the UE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the UE-r functions described herein (e.g., executing, by the processor 902, instructions stored in the memory 904). For example, the processor 902 may support wireless communication at the UE 900 in accordance with examples as disclosed herein. The UE 900 may be configured to support a means for generating a HARQ feedback based on a data transmission received from a SL UE-t. In certain implementations, the UE 900 may be further configured to perform a decoding procedure on the data transmission, where the HARQ feedback indicates a result of the decoding procedure.

The UE 900 may be configured to support a means for performing a CCA. In some implementations, to perform the CCA, the UE 900 may be configured to compare an amount of detected energy with an energy detection threshold. In such implementations, the CCA yields the negative result in response to the amount of detected energy satisfying the energy detection threshold and yields a positive result when the amount of detected energy does not reach the energy detection threshold. In some implementations, the CCA failure information indicates a consistent LBT failure condition of the RB set.

In some implementations, the UE 900 may be further configured to transmit the HARQ feedback based on a positive CCA result. In certain implementations, the HARQ feedback is sent on a PSFCH. In such implementations, the UE 900 may be configured to derive a set of physical resources for transmitting the HARQ feedback based on a set of resources used to receive the data transmission.

In certain implementations, the UE 900 may be further configured to initiate a timer in response to the negative CCA result. In such implementations, the transmission of the message is further based at least in part on the counter reaching the predefined value prior to expiry of the timer. In certain implementations, the UE 900 may be configured to reset or decrement the counter in response to a positive result associated with a subsequent CCA. In further implementations, the UE 900 may be configured to stop or reset the timer in response to the positive result of the subsequent CCA.

The UE 900 may be configured to support a means for incrementing a counter based on a negative CCA result. In some implementations, the counter is specific to the RB set. In such implementations, to increment the counter, the UE 900 may be further configured to increment the counter in response to a negative CCA result specific to the RB set.

In some implementations, the counter is specific to a source-destination pair. In such implementations, to increment the counter, the UE 900 may be further configured to increment the counter in response to a negative CCA result specific to the source-destination pair. In certain implementations, the UE 900 may be configured to maintain a second counter specific to the RB set and to increment the second counter in response to a negative CCA result specific to the RB set. In such implementations, the transmission of the message is further based at least in part on the second counter reaching a second predefined value.

The UE 900 may be configured to support a means for transmitting a message to the SL UE-t based at least in part on the counter reaching a predefined value, the message comprising CCA failure information for a RB set. In some implementations, the RB set comprises a first RB set, where the UE 900 is further configured to receive the data transmission from the SL UE-t on the first RB set and to perform the CCA on the first RB set. In such implementations, the UE 900 may be configured to transmit the message on a second RB set different than the first RB set.

In certain implementations, the UE 900 may be configured to perform a resource selection procedure in response to the counter reaching the predefined value. In such implementations, the second RB set is selected using the resource selection procedure. In some implementations, the UE 900 may be configured to later transmit an update to the SL UE-t, where the update indicates that the RB set is available for use.

In some implementations, the message comprises a MAC CE or a SCI transmission. In some implementations, the message includes one or more of: A) an identification of the RB set; B) a RP identification associated with the RB set; C) a recommended RB Set identification; D) a recommended RP identification; E) a HPID for each TB associated with a failed decoding; F) a HPID for each TB associated with a successful decoding and for which an individual feedback was unable to be transmitted due to the negative CCA result; G) an aggregated HARQ Feedback associated with each TB for which an individual feedback was unable to be transmitted due to the negative CCA result; H) a list of SNs corresponding to each TB associated with a failed decoding; I) a list of SNs corresponding to each TB associated with a successful decoding and for which an individual feedback was unable to be transmitted due to the negative CCA result; J) a triggering condition flag or cause value; or K) a combination thereof.

In some implementations, the processor 902 and the memory 904 coupled with the processor 902 may be configured to cause the UE 900 to perform one or more of the UE-t functions described herein (e.g., executing, by the processor 902, instructions stored in the memory 904). For example, the processor 902 may support wireless communication at the UE 900 in accordance with examples as disclosed herein. The UE 900 may be configured to support a means for transmitting, to a SL UE-r, a SL data transmission on a first RB set. In some implementations, the UE 900 may be configured to transmit SCI with the SL data transmission, wherein the SCI indicates an SN corresponding to each TB associated with the SL data transmission.

The UE 900 may be configured to support a means for receiving, from the SL UE-r, a message on a second RB set, the message comprising CCA failure information for the first RB set. In some implementations, the message comprises a MAC CE or a SCI transmission. In further implementations, the UE 900 may be configured to report the contents of the message to a RAN (e.g., gNB).

In some implementations, the message includes one or more of: A) an identification of the RB set; B) a RP identification associated with the RB set; C) a recommended RB Set identification; D) a recommended RP identification; E) a HPID for each TB associated with a failed decoding; F) a HPID for each TB associated with a successful decoding and for which an individual feedback was unable to be transmitted due to the negative CCA result; G) an aggregated HARQ Feedback associated with each TB for which an individual feedback was unable to be transmitted due to the negative CCA result; H) a list of SNs corresponding to each TB associated with a failed decoding; I) a list of SNs corresponding to each TB associated with a successful decoding and for which an individual feedback was unable to be transmitted due to the negative CCA result; J) a triggering condition flag or cause value; or K) a combination thereof.

In some implementations, the UE 900 is further configured to initiate a timer in response to receiving the message on the second RB set and to perform one or more new transmissions on the first RB set in response to expiry of the timer. In some implementations, the UE 900 may be configured to receive, from the SL UE-r, an update indicating that the first RB set is available for use and to perform one or more new transmissions on the first RB set based on the update.

The UE 900 may be configured to support a means for performing a retransmission of the SL data transmission based on the CCA failure information. In some implementations, to perform the retransmission, the UE 900 is further configured to retransmit the SL data transmission on the first RB set and to indicate that no HARQ feedback is to be sent for the retransmission. In some implementations, to perform the retransmission, the UE 900 is configured to perform a transmission repetition of the SL data transmission on the first RB set and to indicate that no HARQ feedback is to be sent for the transmission repetition.

In some implementations, to perform the retransmission, the UE 900 is configured to retransmit the SL data transmission on a new RB set different than the first RB set. In some implementations, to perform the retransmission, the UE 900 is configured to perform a transmission repetition the SL data transmission on a new RB set different than the first RB set.

In some implementations, the UE 900 is further configured to perform one or more new transmissions on a new RB set different than the first RB set. In certain implementations, the new RB set corresponds to the second RB set. In other implementations, the UE 900 is further configured to perform a resource selection procedure in response to the message, where the new RB set is selected using the resource selection procedure. In such implementations, the resource selection procedure considers the first RB set as unusable.

In further implementations, the UE 900 may be configured to initiate a DTX counter for tracking a consecutive number of SL DTX instances and to increment the DTX counter in response to failing to receive a HARQ feedback corresponding to the SL data transmission. In certain implementations, the UE 900 may be configured to reset the DTX counter to zero in response to receiving the message on the second RB set. In other implementations, the UE 900 may be configured to decrement the DTX counter by a certain amount in response to receiving the message on the second RB set. In such implementations, wherein the certain amount corresponds to a number of PSFCH DTX instances associated with the SL UE-r.

In some implementations, the UE 900 may be further configured to initiate a DTX counter for tracking a consecutive number of SL DTX instances and to perform a resource selection procedure prior to the DTX counter reaching a predetermined maximum number of consecutive SL DTX instances. In such implementations, the retransmission of the SL data transmission is performed after the resource selection procedure. In further implementations, the UE 900 may be configured to determine radio link failure in response to the DTX counter reaching the predetermined maximum number of consecutive SL DTX instances after the resource selection procedure.

In certain implementations, the DTX counter is specific to a source-destination pair. In further implementations, the UE 900 may be configured to determine a likely cause of a particular DTX instance and to suppress incrementing the DTX counter in response to determining that the likely cause of the particular DTX instance is CCA failure.

The controller 906 may manage input and output signals for the UE 900. The controller 906 may also manage peripherals not integrated into the UE 900. In some implementations, the controller 906 may utilize an operating system (OS) such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding/processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

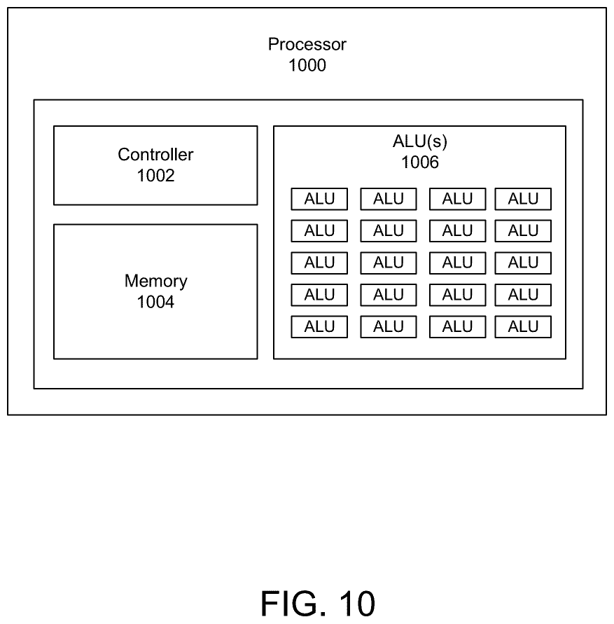

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory address of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, arithmetic logic units (ALUs), and other functional units of the processor 1000.

The memory 1004 may include one or more caches (e.g., memory local to or included in the processor 1000 or other memory, such RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, the controller 1002, and the memory 1004 may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication of a UE-r in accordance with examples as disclosed herein. The processor 1000 may be configured to support a means for generating a HARQ feedback based on a data transmission received from a SL UE-t. In certain implementations, the processor 1000 may be further configured to perform a decoding procedure on the data transmission, where the HARQ feedback indicates a result of the decoding procedure.

The processor 1000 may be configured to support a means for performing a CCA. In some implementations, to perform the CCA, the processor 1000 may be configured to compare an amount of detected energy with an energy detection threshold. In such implementations, the CCA yields the negative result in response to the amount of detected energy satisfying the energy detection threshold and yields a positive result when the amount of detected energy does not reach the energy detection threshold. In some implementations, the CCA failure information indicates a consistent LBT failure condition of the RB set.

In some implementations, the processor 1000 may be further configured to transmit the HARQ feedback based on a positive CCA result. In certain implementations, the HARQ feedback is sent on a PSFCH. In such implementations, the processor 1000 may be configured to derive a set of physical resources for transmitting the HARQ feedback based on a set of resources used to receive the data transmission.

In certain implementations, the processor 1000 may be further configured to initiate a timer in response to the negative CCA result. In such implementations, the transmission of the message is further based at least in part on the counter reaching the predefined value prior to expiry of the timer. In certain implementations, the processor 1000 may be configured to reset or decrement the counter in response to a positive result associated with a subsequent CCA. In further implementations, the processor 1000 may be configured to stop or reset the timer in response to the positive result of the subsequent CCA.

The processor 1000 may be configured to support a means for incrementing a counter based on a negative CCA result. In some implementations, the counter is specific to the RB set. In such implementations, to increment the counter, the processor 1000 may be further configured to increment the counter in response to a negative CCA result specific to the RB set.

In some implementations, the counter is specific to a source-destination pair. In such implementations, to increment the counter, the processor 1000 may be further configured to increment the counter in response to a negative CCA result specific to the source-destination pair. In certain implementations, the processor 1000 may be configured to maintain a second counter specific to the RB set and to increment the second counter in response to a negative CCA result specific to the RB set. In such implementations, the transmission of the message is further based at least in part on the second counter reaching a second predefined value.

The processor 1000 may be configured to support a means for transmitting a message to the SL UE-t based at least in part on the counter reaching a predefined value, the message comprising CCA failure information for a RB set. In some implementations, the RB set comprises a first RB set, where the processor 1000 is further configured to receive the data transmission from the SL UE-t on the first RB set and to perform the CCA on the first RB set. In such implementations, the processor 1000 may be configured to transmit the message on a second RB set different than the first RB set.

In certain implementations, the processor 1000 may be configured to perform a resource selection procedure in response to the counter reaching the predefined value. In such implementations, the second RB set is selected using the resource selection procedure. In some implementations, the processor 1000 may be configured to later transmit an update to the SL UE-t, where the update indicates that the RB set is available for use.

In some implementations, the message comprises a MAC CE or a SCI transmission. In some implementations, the message includes one or more one of: A) an identification of the RB set; B) a RP identification associated with the RB set; C) a recommended RB Set identification; D) a recommended RP identification; E) a HPID for each TB associated with a failed decoding; F) a HPID for each TB associated with a successful decoding and for which an individual feedback could not be transmitted due to the negative CCA result; G) an aggregated HARQ Feedback associated with each TB for which an individual feedback could not be transmitted due to the negative CCA result; H) a list of SNs corresponding to each TB associated with a failed decoding; I) a list of SNs corresponding to each TB associated with a successful decoding and for which an individual feedback could not be transmitted due to the negative CCA result; J) a triggering condition flag or cause value; or K) a combination thereof.

In some implementations, the processor 1000 may support wireless communication of a UE-t in accordance with examples as disclosed herein. The processor 1000 may be configured to support a means for transmitting, to a sidelink SL UE-r, a SL data transmission on a first RB set. In some implementations, the processor 1000 may be configured to transmit SCI with the SL data transmission, wherein the SCI indicates an SN corresponding to each TB associated with the SL data transmission.

The processor 1000 may be configured to support a means for receiving, from the SL UE-r, a message on a second RB set, the message comprising CCA failure information for the first RB set. In some implementations, the message comprises a MAC CE or a SCI transmission. In further implementations, the processor 1000 may be configured to report the contents of the message to a RAN (e.g., gNB).

In some implementations, the message includes one or more of: A) an identification of the RB set; B) a RP identification associated with the RB set; C) a recommended RB Set identification; D) a recommended RP identification; E) a HPID for each TB associated with a failed decoding; F) a HPID for each TB associated with a successful decoding and for which an individual feedback could not be transmitted due to the negative CCA result; G) an aggregated HARQ Feedback associated with each TB for which an individual feedback could not be transmitted due to the negative CCA result; H) a list of SNs corresponding to each TB associated with a failed decoding; I) a list of SNs corresponding to each TB associated with a successful decoding and for which an individual feedback could not be transmitted due to the negative CCA result; J) a triggering condition flag or cause value; or K) a combination thereof.

In some implementations, the processor 1000 is further configured to initiate a timer in response to receiving the message on the second RB set and to perform one or more new transmissions on the first RB set in response to expiry of the timer. In some implementations, the processor 1000 may be configured to receive, from the SL UE-r, an update indicating that the first RB set is available for use and to perform one or more new transmissions on the first RB set based on the update.

The processor 1000 may be configured to support a means for performing a retransmission of the SL data transmission based on the CCA failure information. In some implementations, to perform the retransmission, the processor 1000 is further configured to retransmit the SL data transmission on the first RB set and to indicate that no HARQ feedback is to be sent for the retransmission. In some implementations, to perform the retransmission, the processor 1000 is configured to perform a transmission repetition of the SL data transmission on the first RB set and to indicate that no HARQ feedback is to be sent for the transmission repetition.

In some implementations, to perform the retransmission, the processor 1000 is configured to retransmit the SL data transmission on a new RB set different than the first RB set. In some implementations, to perform the retransmission, the processor 1000 is configured to perform a transmission repetition the SL data transmission on a new RB set different than the first RB set.

In some implementations, the processor 1000 is further configured to perform one or more new transmissions on a new RB set different than the first RB set. In certain implementations, the new RB set corresponds to the second RB set. In other implementations, the processor 1000 is further configured to perform a resource selection procedure in response to the message, where the new RB set is selected using the resource selection procedure. In such implementations, the resource selection procedure considers the first RB set as unusable.

In further implementations, the processor 1000 may be configured to initiate a DTX counter for tracking a consecutive number of SL DTX instances and to increment the DTX counter in response to failing to receive a HARQ feedback corresponding to the SL data transmission. In certain implementations, the processor 1000 may be configured to reset the DTX counter to zero in response to receiving the message on the second RB set. In other implementations, the processor 1000 may be configured to decrement the DTX counter by a certain amount in response to receiving the message on the second RB set. In such implementations, wherein the certain amount corresponds to a number of PSFCH DTX instances associated with the SL UE-r.

In some implementations, the processor 1000 may be further configured to initiate a DTX counter for tracking a consecutive number of SL DTX instances and to perform a resource selection procedure prior to the DTX counter reaching a predetermined maximum number of consecutive SL DTX instances. In such implementations, the retransmission of the SL data transmission is performed after the resource selection procedure. In further implementations, the processor 1000 may be configured to determine radio link failure in response to the DTX counter reaching the predetermined maximum number of consecutive SL DTX instances after the resource selection procedure.

In certain implementations, the DTX counter is specific to a source-destination pair. In further implementations, the processor 1000 may be configured to determine a likely cause of a particular DTX instance and to suppress incrementing the DTX counter in response to determining that the likely cause of the particular DTX instance is CCA failure.

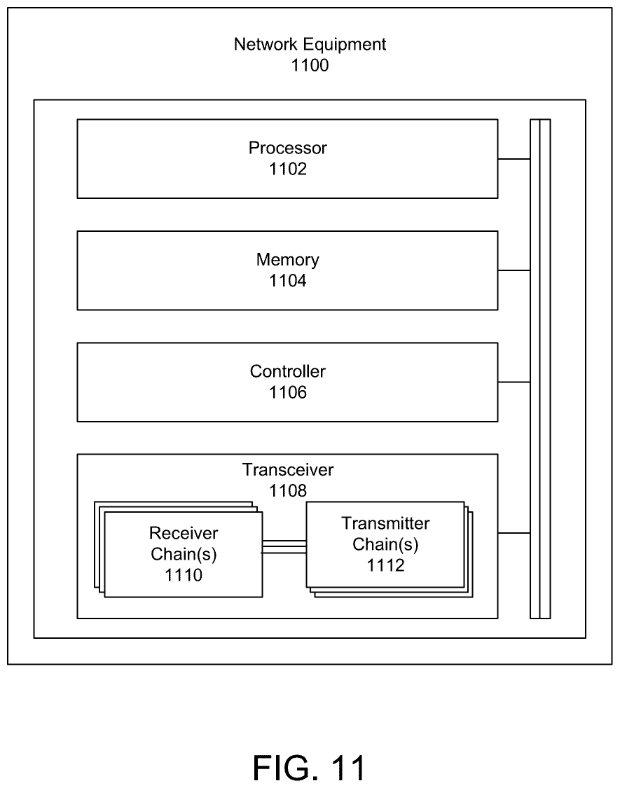

FIG. 11 illustrates an example of a NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receiving the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the received signal and obtain the transmitted data by reversing the modulation technique applied during transmission of the signal. The receiver chain 1110 may include at least one decoder for decoding/processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

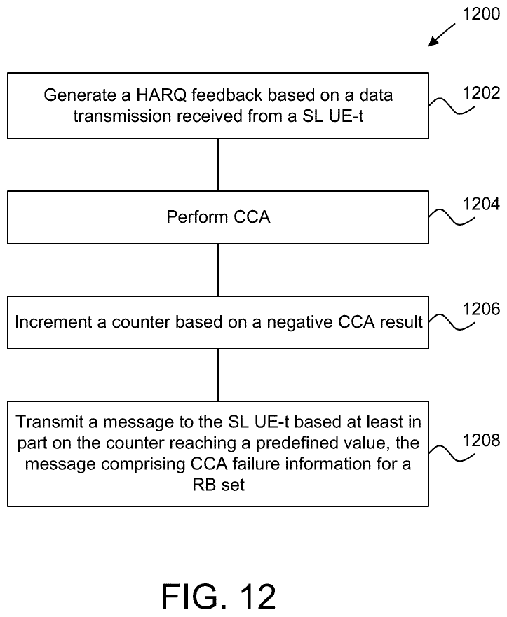

FIG. 12 depicts one embodiment of a method 1200 in accordance with aspects of the present disclosure. The operations of the method 1200 may be implemented by a UE-r as described herein. In some implementations, the UE-r may execute a set of instructions to control the function elements of the UE-r to perform the described functions.

At step 1202, the method 1200 may include generating a HARQ feedback based on a data transmission received from a SL UE-t. The operations of step 1202 may be performed in accordance with examples as described herein. In some implementations, aspects of the operations of step 1202 may be performed by a UE-r as described with reference to FIG. 9.

At step 1204, the method 1200 may include performing a CCA. The operations of step 1204 may be performed in accordance with examples as described herein. In some implementations, aspects of the operations of step 1204 may be performed by a UE-r as described with reference to FIG. 9.

At step 1206, the method 1200 may include incrementing a counter based on a negative CCA result. The operations of step 1206 may be performed in accordance with examples as described herein. In some implementations, aspects of the operations of step 1206 may be performed a UE-r as described with reference to FIG. 9.

At step 1208, the method 1200 may include transmitting a message to the SL UE-t based at least in part on the counter reaching a predefined value, the message comprising CCA failure information for a RB set. The operations of step 1208 may be performed in accordance with examples as described herein. In some implementations, aspects of the operations of step 1208 may be performed a UE-r as described with reference to FIG. 9.

It should be noted that the method 1200 described herein describes one possible implementation, and that the operations and the steps may be rearranged or otherwise modified and that other implementations are possible.

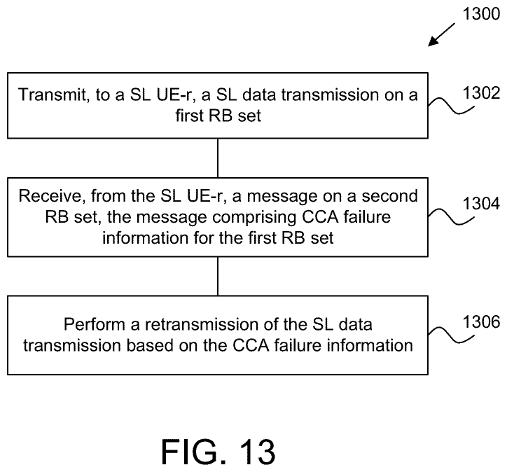

FIG. 13 depicts one embodiment of a method 1300 in accordance with aspects of the present disclosure. The operations of the method 1300 may be implemented by a UE-t as described herein. In some implementations, the UE-t may execute a set of instructions to control the function elements of the UE-t to perform the described functions.

At step 1302, the method 1300 may include transmitting, to a SL UE-r, a SL data transmission on a first RB set. The operations of step 1302 may be performed in accordance with examples as described herein. In some implementations, aspects of the operations of step 1302 may be performed by a UE-t as described with reference to FIG. 9.

At step 1304, the method 1300 may include receiving, from the SL UE-r, a message on a second RB set, the message comprising CCA failure information for the first RB set. The operations of step 1304 may be performed in accordance with examples as described herein. In some implementations, aspects of the operations of step 1304 may be performed by a UE-t as described with reference to FIG. 9.

At step 1306, the method 1300 may include performing a retransmission of the SL data transmission based on the CCA failure information. The operations of step 1306 may be performed in accordance with examples as described herein. In some implementations, aspects of the operations of step 1306 may be performed a UE-t as described with reference to FIG. 9.

It should be noted that the method 1300 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
generate a hybrid automatic repeat request (HARQ) feedback based on a data transmission received from a sidelink (SL) transmitter UE (UE-t);
perform a Clear Channel Assessment (CCA);
increment a counter based on a negative CCA result; and
transmit a message to the SL UE-t based at least in part on the counter reaching a predefined value, the message comprising CCA failure information for a Resource Block (RB) set.

2. The UE of claim 1, wherein the at least one processor is configured to cause the UE to:
perform a decoding procedure on the data transmission; and
transmit the HARQ feedback based on a positive CCA result, wherein the HARQ feedback indicates a result of the decoding procedure.

3. The UE of claim 1, wherein the RB set comprises a first RB set, and wherein the at least one processor is configured to cause the UE to:
receive the data transmission from the SL UE-t on the first RB set;
perform the CCA on the first RB set; and
transmit the message on a second RB set different than the first RB set.

4. The UE of claim 1, wherein the CCA failure information indicates a continuous listen-before-talk (C-LBT) failure condition of the RB set.

5. The UE of claim 1, wherein the at least one processor is configured to cause the UE to, and.

6. The UE of claim 1, wherein the at least one processor is configured to cause the UE to initiate a timer in response to the negative CCA result, and wherein transmitting the message is further based at least in part on the counter reaching the predefined value prior to expiry of the timer.

7. The UE of claim 1, wherein the message comprises:
an identification of the RB set;
a Resource Pool (RP) identification associated with the RB set;
a recommended RB Set identification;
a recommended RP identification;
a HARQ process identifier (HPID) for each transport block (TB) associated with a failed decoding;
a HPID for each TB associated with a successful decoding and for which an individual feedback was unable to be transmitted due to the negative CCA result;
an aggregated HARQ Feedback associated with each TB for which an individual feedback was unable to be transmitted due to the negative CCA result;
a list of sequence numbers (SNs) corresponding to each TB associated with a failed decoding;
a list of SNs corresponding to each TB associated with a successful decoding and for which an individual feedback was unable to be transmitted due to the negative CCA result;
a triggering condition flag or cause value;
or a combination thereof.

8. The UE of claim 1, wherein the counter is specific to the RB set, and wherein to increment the counter, the at least one processor is configured to cause the UE to increment the counter in response to a negative CCA result specific to the RB set.

9. The UE of claim 1, wherein the counter is specific to a source-destination pair, and wherein to increment the counter, the at least one processor is configured to cause the UE to increment the counter in response to a negative CCA result specific to the source-destination pair.

10. A processor for wireless communication, comprising:
at least one controller coupled with at least one memory and configured to cause the processor to:
generate a hybrid automatic repeat request (HARQ) feedback based on a data transmission received from a sidelink (SL) transmitter user equipment (UE-t);
perform a Clear Channel Assessment (CCA);
increment a counter based on a negative CCA result; and
transmit a message to the SL UE-t based at least in part on the counter reaching a predefined value, the message comprising CCA failure information for a Resource Block (RB) set.

11. A user equipment (UE) for wireless communication, comprising:
at least one memory; and
at least one processor coupled with the at least one memory and configured to cause the UE to:
transmit, to a sidelink (SL) receiver UE (UE-r), a SL data transmission on a first resource block (RB) set;
receive, from the SL UE-r, a message on a second RB set, the message comprising Clear Channel Assessment (CCA) failure information for the first RB set; and
perform a retransmission of the SL data transmission based on the CCA failure information.

12. The UE of claim 11, wherein to perform the retransmission, the at least one processor is configured to cause the UE to:
retransmit the SL data transmission on the first RB set, and
indicate that no hybrid automatic repeat request (HARQ) feedback is to be sent for the retransmission.

13. The UE of claim 11, wherein to perform the retransmission, the at least one processor is configured to cause the UE to:
perform a transmission repetition of the SL data transmission on the first RB set, and indicate that no hybrid automatic repeat request (HARQ) feedback is to be sent for the transmission repetition.

14. The UE of claim 11, wherein to perform the retransmission, the at least one processor is configured to cause the UE to retransmit the SL data transmission on a new RB set different than the first RB set, wherein the new RB set corresponds to the second RB set or a respective RB set selected using a resource selection procedure.

15. The UE of claim 11, wherein to perform the retransmission, the at least one processor is configured to cause the UE to perform a transmission repetition of the SL data transmission on a new RB set different than the first RB set, wherein the new RB set corresponds to the second RB set or a respective RB set selected using a resource selection procedure.

16. The UE of claim 11, wherein the at least one processor is configured to cause the UE to perform one or more new transmissions on a new RB set different than the first RB set, wherein the new RB set corresponds to the second RB set or a respective RB set selected using a resource selection procedure.

17. The UE of claim 11, wherein the at least one processor is further configured to cause the UE to transmit SL Control Information (SCI) with the SL data transmission, wherein the SCI indicates a sequence number (SN) corresponding to each transport block (TB) associated with the SL data transmission.

18. The UE of claim 11, wherein the at least one processor is further configured to cause the UE to:
receive, from the SL UE-r, an update indicating that the first RB set is available for use; and
perform one or more new transmissions on the first RB set based on the update.

19. The UE of claim 11, wherein the at least one processor is configured to cause the UE to:
initiate a timer in response to receiving the message on the second RB set; and
perform one or more new transmissions on the first RB set in response to expiry of the timer.

20. A processor for wireless communication, comprising:
at least one controller coupled with at least one memory and configured to cause the processor to:
transmit, to a sidelink (SL) receiver UE (UE-r), a SL data transmission on a first resource block (RB) set;
receive, from the SL UE-r, a message on a second RB set, the message comprising Clear Channel Assessment (CCA) failure information for the first RB set; and
perform a retransmission of the SL data transmission based on the CCA failure information.
